(19) United States
(12) Patent Application Publication
(10) Pub. No.: US 2016/0067830 A1
(43) Pub. Date: Mar. 10, 2016

(54) HOUSING FOR A LASER HEAD, LASER MATERIAL REMOVAL APPARATUS INCLUDING THE HOUSING, AND SYSTEM FOR MATERIAL REMOVAL, LATHE, AND METHODS OF MANUFACTURING USING THE SAME

(71) Applicant: MORRIS GROUP, INC., Windsor, CT (US)

(72) Inventor: Dale White, Windsor, CT (US)

(21) Appl. No.: 14/538,855

(22) Filed: Nov. 12, 2014

Related U.S. Application Data
(60) Provisional application No. 62/046,589, filed on Sep. 5, 2014.

(51) Int. Cl. B23K 26/38; B23B 27/00

(52) U.S. Cl. CPC B23K 26/38; B23B 27/00

(57) ABSTRACT

A housing for a laser head, the housing including: a bottom cover; a top cover on the bottom cover; a nozzle on a side surface of at least one of the bottom cover and the top cover; and a gas flow path extending from a posterior portion of the nozzle to an inlet in at least one of the bottom cover and the top cover. Also a laser material removal apparatus including the housing, a lathe including the laser material removal apparatus, and methods of using the same.

### CROSS-REFERENCE TO RELATED APPLICATION

This application claims priority to and the benefit of U.S. Provisional Patent Application Ser. No. 62/046,589, filed on Sep. 5, 2014, the content of which is incorporated herein by reference in its entirety.

### BACKGROUND

1. Field of the Disclosure

This disclosure relates to a housing for a laser head, a laser material removal apparatus including the housing, and a system for material removal, a lathe, and methods of manufacturing using the same.

2. Description of the Related Art

Products are manufactured using a variety and a combination of processes. Certain products, such as tubular products, are manufactured using a combination of rotary machining, such as machining using a cutting tool on a lathe, and laser machining. Because of incompatibility between a rotary machining environment and laser equipment, between rotary machining and laser machining operations manufacturing processes are stopped and the workpiece is transferred from a rotary machine to a laser machine and re-registered, often by human intervention. It would be desirable to perform both rotary machining and laser machining in a single operation, however a cutting fluid, which is utilized during rotary machining, may damage laser equipment or reduce the effectiveness of laser operations, preventing performing both rotary machining and laser machining in a single operation. Thus there remains a need for equipment and methods to provide rotary machining and laser machining in a single operation.

### SUMMARY

Disclosed is a housing for a laser head, the housing including: a bottom cover; a top cover on the bottom cover; a nozzle on a side surface of at least one of the bottom cover and the top cover; and a gas flow path extending from a posterior portion of the nozzle to an inlet in at least one of the bottom cover and the top cover.

Also disclosed is a laser material removal apparatus comprising a laser head disposed in the housing.

Also disclosed is a lathe including: a headstock; a tailstock; a means for providing a cutting fluid flow; and the laser material removal apparatus of claim 8, wherein the headstock, the tailstock, and the laser head are within a cabinet.

Also disclosed is a method of metalworking, the method including: providing a workpiece; providing a cutting tool; providing a laser material removal apparatus including a housing including a bottom cover, a top cover on the bottom cover, a nozzle on a side surface of at least one of the bottom cover and the top cover, and a gas flow path extending from a posterior portion of the nozzle to an inlet in at least one of the bottom cover and the top cover, and a laser head disposed in the housing and in optical communication with a laser; providing a gas flow to the gas flow path; providing a cutting fluid flow associated with the workpiece, wherein the cutting fluid flow, the cutting tool, and the laser material removal apparatus are in a cabinet; rotating the workpiece; removing material from the workpiece with the cutting tool; and removing material from the workpiece with the laser.

Examples of the more important features of certain embodiments and methods have been summarized rather broadly in order that the detailed description thereof that follows may be better understood, and in order that the contributions to the art may be appreciated. There are, of course, additional features that will be described hereinafter and which will form the subject of the claims.

### BRIEF DESCRIPTION OF THE DRAWINGS

For a detailed understanding of the apparatus and methods disclosed herein, reference should be made to the accompanying drawings and the detailed description thereof, wherein like elements are generally given same numerals and wherein:

FIG. 1A shows a schematic diagram of an embodiment of a machining system;

FIG. 1B shows a simplified elevation view of the machining system shown in FIG. 1A;

FIG. 1C shows a perspective view of the machining system shown in FIG. 1A;

FIG. 2A shows an embodiment of a housing for a laser material removal apparatus for use in a machining system, including the system shown in FIG. 1A;

FIG. 2B shows a cross-sectional elevation view of the laser material removal apparatus shown in FIG. 2A; and

FIG. 3 shows an embodiment of a valve box for use in a machining system, including the system shown in FIG. 1A.

### DETAILED DESCRIPTION

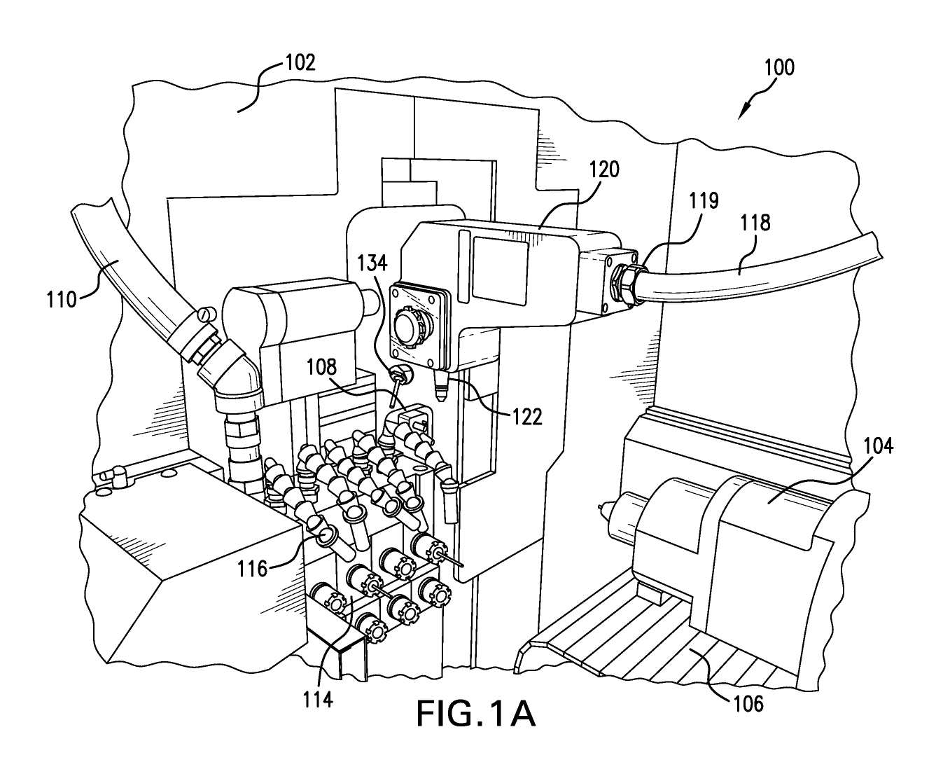

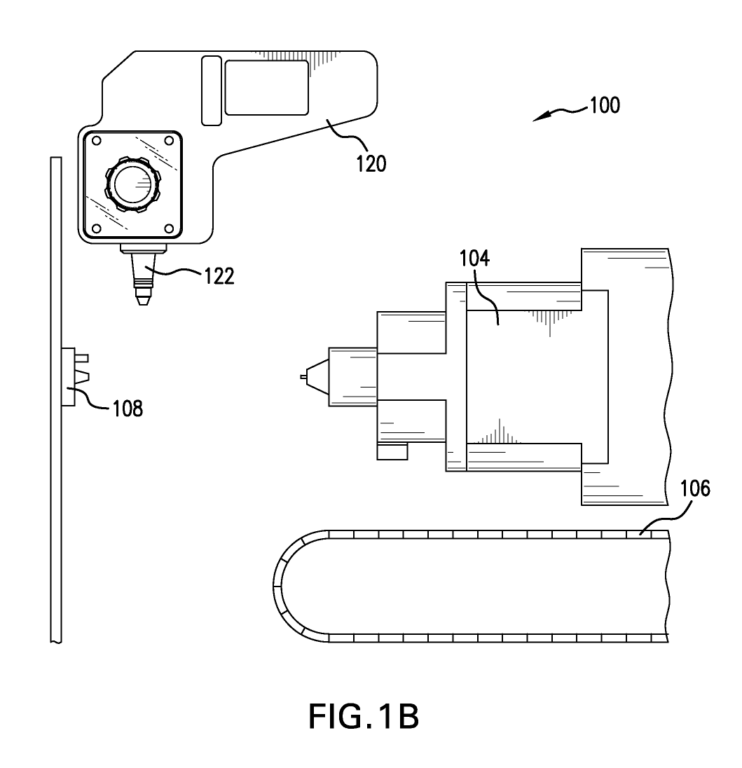

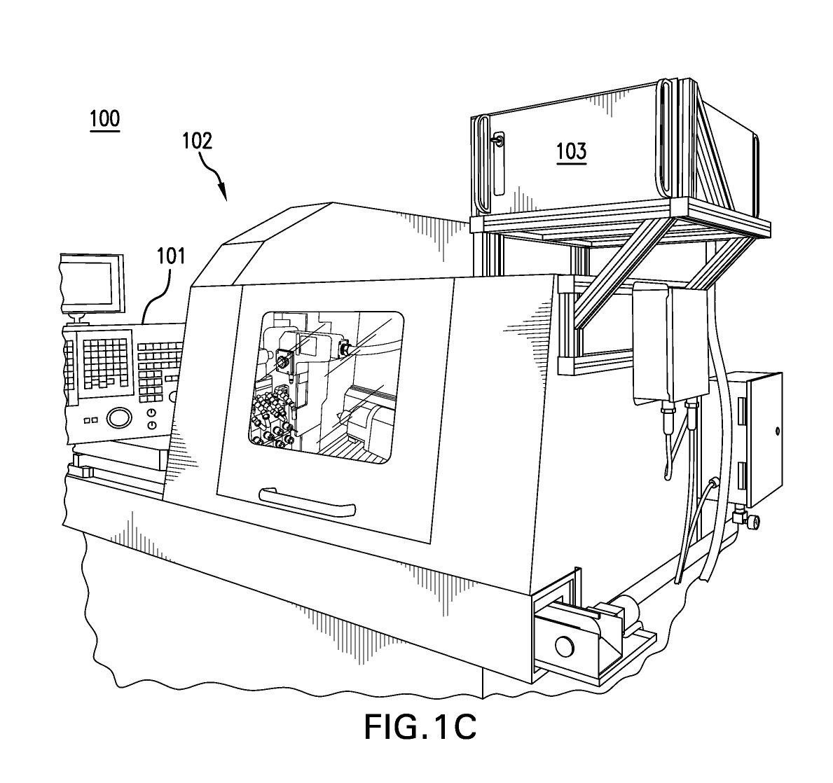

FIGS. 1A-1C illustrate a machining system 100 that may be used for machining operations. In an exemplary embodiment, the machining system 100 includes a cabinet 102, a fixed or sliding headstock with a spindle 108, a laser material removal apparatus 120, and a cutting tool 112. In certain embodiments, a tailstock 104 may be included, the tailstock 104 optionally comprising a pick-off spindle or sub-spindle. The tailstock 104 may be disposed on a table 106. Within the cabinet 102 a cutting fluid may be provided by a supply 110, which directs the cutting fluid to a cutting fluid nozzle 134, a flood nozzle 116, or a combination thereof.

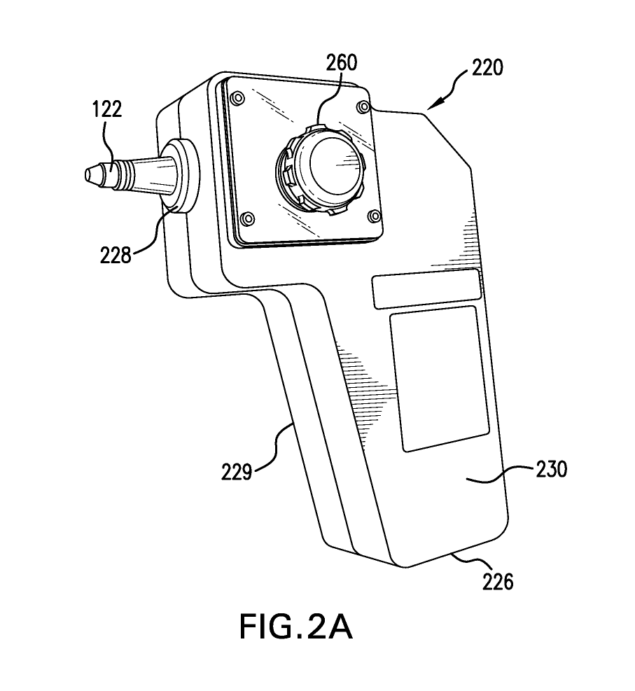

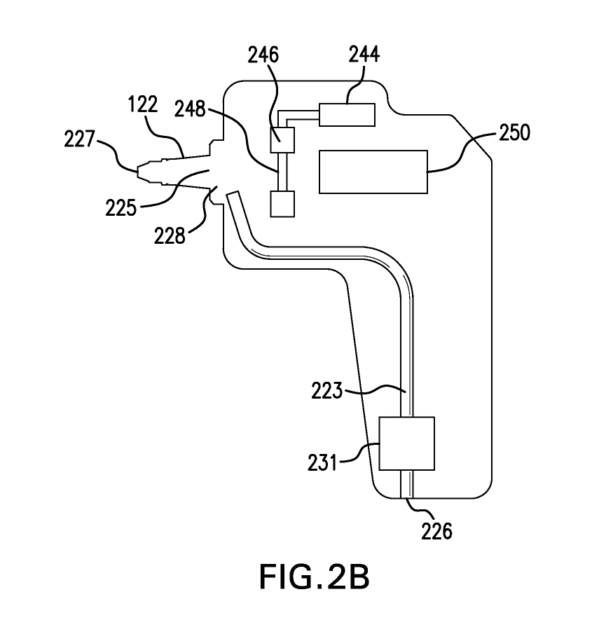

The laser material removal apparatus 120 comprises a laser head 250 which is disposed within a housing 220, as shown in FIGS. 2A and 2B. The housing 220 generally encloses laser head 250. As is further discussed below, the housing 220 allows for use of the laser head 250 within the cabinet 102 of the machining system 100, and allows for rotary machining and laser machining in a single operation. The housing 220 comprises a nozzle 122, which is retained to a side surface of at least one of a top cover 230 and a bottom cover 229 of the housing by an extension nut 228. Also provided in the top cover 230 is an access 260, which provides access to an interior of the housing, e.g., for adjusting a lens or a cover glass disposed within the housing. The access 260 may be threadedly engaged to the top cover 230. The housing 220 may be made of any suitable material, such as a metal such as aluminum, a polymeric material such as polycarbonate, a composite, or a combination thereof. The material of the housing 220 may be selected to resist contaminants that may degrade the performance of the laser head 250.

The laser head 250 is in optical communication with a laser supply 103 via a fiber cable 118. The fiber cable 118 provides for directing laser light to the laser head 250, which in turn directs the laser light out the nozzle 122. The fiber cable 118 passes through a connector 119, which is disposed on a bottom of the housing 220. The connector 119 provides a sealed connection to prevent cutting fluid or air from the cabinet from entering the housing via the inlet. Also provided within the fiber cable 118 is a gas supply, which provides a gas flow to a gas flow path 223, as shown in FIG. 2B.

The laser may be any suitable type of laser, including, but not limited to, a fiber laser. A fiber laser is a laser in which the active gain medium is an optical fiber doped with a rare-earth element. The rare earth element may be erbium, ytterbium, neodymium, dysprosium, praseodymium, thulium, or a combination thereof. A laser wherein the gain medium is a fiber doped with a rare earth ion such as erbium (Er³⁺), neodymium (Nd³⁺), ytterbium (Yb³⁺), thulium (Tm³⁺), or praseodymium (Pr³⁺), and wherein a fiber-coupled laser diode is used for pumping, is specifically mentioned. A laser of the laser supply may be a fiber laser, and the laser head 250 may be a fiber laser head.

As shown in FIG. 2B, the focus of laser head 250 may be adjusted by moving lens carrier 246 and lens 248. The lens may be disposed on a beam path and between the laser head and the nozzle. In an exemplary embodiment, a servo motor 244 is used to adjust the position of the lens carrier 246 in the assembly to allow focus and adjustment of a focal length of the laser head. In other embodiments, the position of the lens carrier 245 is manually adjusted to adjust the focus of laser head 250. A cover glass, not shown, may be optionally provided between the nozzle and the lens. Laser energy is emitted to the workpiece via nozzle 122.

In order to preserve the performance of the laser head 250, the lens 248, and the cover glass (if present), a gas flow may be utilized to displace contaminants in the cabinet which would otherwise contact the laser head 250, the lens 248, and the cover glass (if present), degrading their performance. Provided within the housing 220 is a gas flow path 223 which extends from an inlet 226 in the housing to a posterior portion 225 of the nozzle 122. A filter 231 may be optionally provided in the gas flow path 223. The gas flow enters the housing through the inlet 226, which may be equipped with the connector 119 to provide a sealed connection. The gas flow may comprise at least one of a purge gas and an assist gas. The gas is directed through the gas flow path 223, e.g., a tube extending from the inlet to the nozzle, to be disposed within the housing 220, specifically to the posterior portion of the nozzle.

The machining system 100 is not specifically limited, and may be a lathe, e.g., a sliding headstock lathe, or may be a milling machine, such as a horizontal mill or a vertical mill, e.g., a column and knee milling machine. As shown in FIG. 1A, the machining system may comprise a fixed or a sliding headstock comprising a spindle 108, the laser material removal apparatus 120, and a cutting tool 112. In certain embodiments, the tailstock 104 may comprise a pick-off spindle or a sub-spindle, and the tailstock 104 may be disposed on a table 106. As is further disclosed above, cabinet 102 contains elements of the machining system 100, prevents contaminants from entering the machining system 100, and prevents shavings and cutting fluid from escaping machining system 100. The laser material removal apparatus 120, the fixed or sliding headstock with a spindle 108, and the cutting tool 112 may all be disposed within the cabinet 102, allowing for rotary machining and laser machining of a workpiece without any secondary operations.

The machining system 100 may be computer controlled and may comprise a controller. In an exemplary embodiment, the workpiece is a tubular workpiece to be machined. In certain embodiments, the workpiece is subject to complex machining operations. Rotary machining and laser machining is capable of being performed in, but not limited to, 5 axes, 6 axes, 1 to 6 axes, 1 to 5 axes, 2 to 6 axes, 2 to 5 axes, or other application specific degrees of freedom. Rotary machining may include turning, threading, milling, drilling, and reaming.

The fixed or sliding headstock with the spindle 108 retains a workpiece therein. In an exemplary embodiment, the headstock with spindle 108 rotates the workpiece at an operator or program selected speed. In certain embodiments, headstock with spindle 108 allows workpiece to translate axially within the fixed or sliding headstock with spindle 108. A sliding headstock is specifically mentioned.

The cutting tool 112 is used in conjunction with the fixed or the sliding headstock with the spindle 108 to machine a workpiece. The cutting tool 112 is selected for the desired application and applied to the workpiece, which is retained in the fixed or the sliding headstock comprising the spindle 108. Representative cutting tools include a drill, an end mill, and a reamer. In an exemplary embodiment, the fixed or the sliding headstock comprising the spindle 108 rotates workpiece to allow the cutting tool 112 to remove material as the cutting tool 112 makes contact with rotating workpiece. The cutting tool 112 may be translated radially and axially relative to the workpiece to perform the desired machining operations. Additional cutting tools 114 may be provided within the cabinet 102.

In an exemplary embodiment, the machining system is a lathe, and the lathe may be a sliding headstock lathe, e.g., a Swiss-type lathe, wherein the cutting tool 112 is disposed very close to the support provided by the sliding headstock with spindle 108 to limit deflection and increase precision of machining operations. A sliding headstock lathe generally comprises a fixed or a sliding headstock, a guide bushing disposed in the direction of the movement of the headstock, and one or more cutting tools for turning operations. The sliding headstock feeds a revolving piece of material through a guide bushing and then into the path of one or more radially mounted tools. The combination of the guide bushing and the radial tool mounting permits exceptionally fine control of the cut or other machining operation. The finished product is then discharged from the lathe and delivered to another machine if secondary machining operations are desired. In an embodiment, a distance between the cutting tool 112 and the sliding headstock is 0.1 millimeter (mm) to 10 mm, specifically 0.5 mm to 5 mm. In certain embodiments, the tailstock 104 may comprise a pick-off spindle which supports the workpiece in addition to the support provided by the spindle 108. A bushing may further support the workpiece. Further, in certain embodiments, the tailstock is disposed on the table 106, which can translate cooperatively with the fixed or the sliding headstock comprising the spindle 108.

In an alternative embodiment, the lathe is a chucker type lathe, wherein the headstock with spindle 108 is fixed and a chuck or other workholding device is utilized to support the workpiece.

During machining operations, the machining system 100 may introduce a cutting fluid within the cabinet 102. The cutting fluid may be provided by a pump, which directs a cutting fluid from a reservoir to the work piece from within the workpiece, via a cutting fluid nozzle 134, via a flood nozzle 116, or a combination thereof. The cutting fluid cools the workpiece, reduces friction between the cutting tool 112 and the workpiece, and displaces particles, e.g., chips, removed from the workpiece. Advantageously, cutting fluid allows for the cutting tool 112 to last longer, and potentially allows for operations to be performed faster.

Before, during, or after rotary machining operations performed with the fixed or the sliding headstock with the spindle 108 and the cutting tool 112, the fixed or the sliding headstock and the laser material removal apparatus 120 may cooperate to perform laser machining operations without removing the workpiece from the headstock comprising the spindle 108. In an exemplary embodiment, laser machining operations are performed simultaneously with rotary machining operations. Use of the laser material removal apparatus 120 to perform laser machining operations can provide machining capability that may not be possible, consistent, or time effective with other methods, wherein such machining capability may include narrow spirals, windows, and slots. The headstock comprising the spindle 108 may cooperatively rotate workpiece to allow laser machining of the workpiece.

To prevent damage to the laser head 250 by a contaminant, such as residual or suspended, e.g., airborne, cutting fluid used during the rotary machining process, the laser material removal apparatus is provided with a gas flow. A controller 101, which is configured to cooperatively control the rotary machining and laser machining operations, may be used, and the controller 101 may control the laser and the gas flows. When the laser material removal apparatus 120 is provided with a gas flow, it may be used in combination with rotary machining operations without substantial degradation to the performance of the laser head 250 or other laser optics which may be provided within the housing 220.

It has been surprisingly discovered that the gas flow is effective to displace a liquid, such as the cutting fluid, or a vapor, such as humid air, to provide an environment within the housing 220 which is compatible with the laser head, including the laser optics such as the lens and cover glass, allowing use of the laser head 250 within the cabinet 102 without degradation, despite exposure of an exterior of the laser material removal apparatus to cutting fluid and humid air during machining operations. While not wanting to be bound by theory, it is understood that the gas flows through the nozzle 122 and out the aperture 227 of the nozzle 122, and that the gas flow is effective in preventing entry of contaminants, such as cutting fluid or humid air, from entering the housing and contaminating the laser head.

The gas flow may comprise a purge gas and/or an assist gas. The gas flow may be subjected to filtration via the filter 231 before being deployed within the housing. In certain embodiments, the gas flow is removed of moisture via a desiccant prior to being deployed within the housing. The purge gas may displace a liquid, such as a cutting fluid, or a gas, such as water vapor, to provide an environment within the laser head which is compatible with the laser optics. In an exemplary embodiment the purge gas flow is subjected to filtration via a filter 231. In certain embodiments, the purge gas flow is also contacted with a desiccant to remove water prior to being deployed within the housing. The purge gas may comprise any suitable gas, and may comprise nitrogen, argon, helium, carbon dioxide, dry air, or a combination thereof. Surprisingly, the use of the purge gas allows the use of the laser head within the cabinet of the machining system during machining operations without degradation to the laser head, despite the presence of cutting fluid and humid air within the cabinet 102. The purge gas flow may be supplied at any suitable positive pressure, e.g., 1 kilopascals (kPa) to 100 kPa, or 2 kPa to 50 kPa, or 4 kPa to 25 kPa. Use of dry air as a purge gas is specifically mentioned.

An assist gas may also be provided. It is appreciated that the gas flow path 223 may alternatively contain the flow of any desired gas. While not wanting to be bound by theory, it is understood that the assist gas aids in the removal of molten material from the work piece, minimizes heat affected zones of the work piece, provides additional shrouding of the work piece, and protects the optics of laser head 250 by displacing cutting fluid flow. In an exemplary embodiment, the assist gas may comprise any suitable gas, and may comprise oxygen, nitrogen, argon, helium, carbon dioxide, dry air, or a combination thereof. In an exemplary embodiment, the assist gas is provided at a suitable positive pressure, e.g., 1 kilopascals (kPa) to 100 kPa, or 2 kPa to 50 kPa, or 4 kPa to 25 kPa. Use of argon as an assist gas is specifically mentioned.

The assist gas flow and the purge gas flow may be selectively controlled to flow during laser machining operations as well as during rotary machining operations. In certain embodiments, the assist gas flow is active during laser machining operations. In certain embodiments, the purge gas flow is active during laser machining operations. In other embodiments, both the assist gas flow and the purge gas flow are active during laser machining operations. In other embodiments, both the assist gas flow and the purge gas flow alternate during laser machining operations. In an exemplary embodiment, if the assist gas flow is stopped, the purge gas flow is activated. Similarly, the assist gas flow and the purge gas flow may be selectively activated during rotary machining operations. In certain embodiments, if rotary machining and laser machining are simultaneously active, assist gas flow and purge gas flow may be provided during both rotary machining and laser machining to provide the benefits described above to the operation and the workpiece.

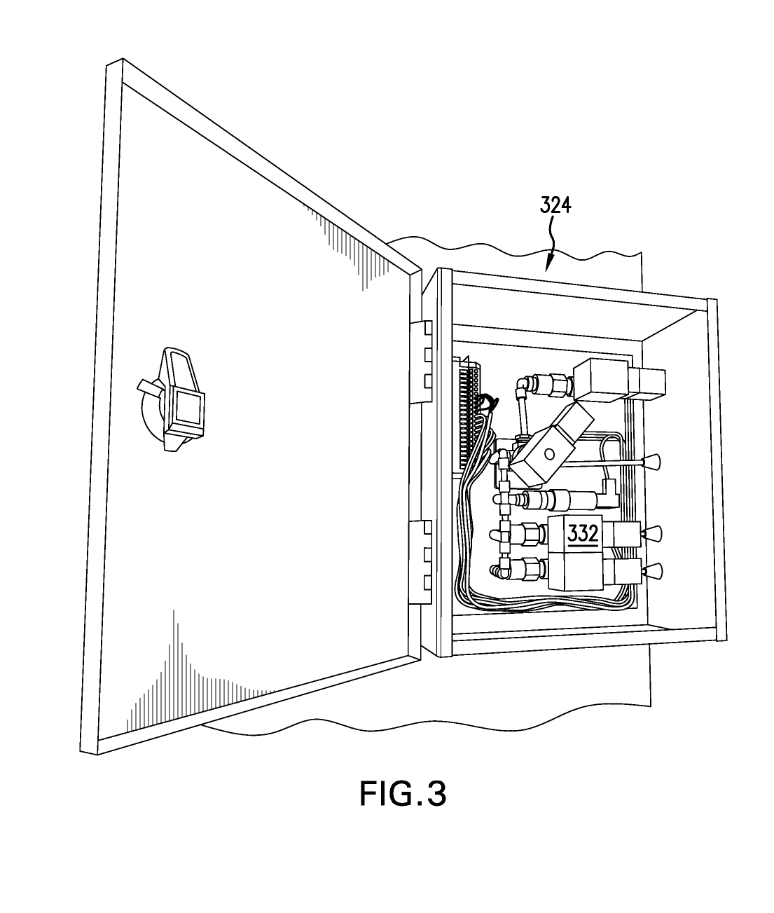

The purge and assist gas flows may be manually controlled, or may be automatically controlled using valves, e.g., solenoid valves as shown in FIG. 3. FIG. 3 shows a non-limiting embodiment of a gas controller 324. The gas controller includes valves 332 for control of the gas flows. In an exemplary embodiment, valves 332 control the flow of both the assist gas and the purge gas.

In an embodiment, the laser is a fiber laser suitable for laser machining operations, as opposed to laser marking. The laser may have a power of greater than 50 watts (W), specifically 50 W to 500 W, or 100 W to 1000 W, or 125 W to 500 W, or 150 W to 400 W, or 175 W to 350 W. A laser with a wavelength of 1070 nanometers (nm) is specifically mentioned. Also, the power of the laser is desirably adjustable. A laser having a power which is adjustable between continuous wave to 10 percent (%) of continuous wave, or continuous wave to 15% of continuous wave, or continuous wave to 20% of continuous wave, is mentioned. Also, the laser may have a modulation range of 1 kilohertz (kHz) to 10 kHz, preferably 1 kHz to 100 kHz, or 1 kHz to 1000 kHz, and may provide a stability of 0.1% to 3%, specifically 0.1% to 1%.

Also disclosed is a method of metalworking, the method comprising: providing a workpiece; providing a cutting tool; providing a laser material removal apparatus comprising a housing comprising a bottom cover, a top cover on the bottom cover, a nozzle on a side surface of at least one of the bottom cover and the top cover, and a gas flow path extending from a posterior portion of the nozzle to an inlet in at least one of the bottom cover and the top cover, and a laser head disposed in the housing and in optical communication with a laser; providing a gas flow to the gas flow path; providing a cutting fluid flow associated with the workpiece, wherein the cutting fluid flow, the cutting tool, and the laser material removal apparatus are in a cabinet; rotating the workpiece; removing material from the workpiece with the cutting tool; and removing material from the workpiece with the laser. In an embodiment the controller 101 controls the rotating of the workpiece, the flow of the cutting fluid, the movement of the cutting tool, and the gas flow. The method may comprise providing a purge gas flow during a rotary machining operation and providing an assist gas flow during a laser machining operation. In an embodiment, rotary and machining operations are performed concurrently. During concurrent rotary and laser machining operation, the purge gas, the assist gas, or a combination thereof may be provided. Use of the assist gas, e.g., nitrogen, during laser machining is mentioned.

Disclosed is a housing for protecting a laser head, the housing comprising: a bottom cover; a top cover on the bottom cover; a nozzle on a side surface of at least one of the bottom cover and the top cover; and a gas flow path extending from a posterior portion of the nozzle to an inlet in at least one of the bottom cover and the top cover.

Also disclosed is a laser material removal apparatus comprising the laser head disposed in the housing.

Also disclosed is a machining system comprising: a headstock; a means for providing a cutting fluid flow; and the laser material removal apparatus, wherein the headstock, the tailstock, and the laser head are within a cabinet of the machining system.

Also disclosed is a lathe comprising: a headstock; a tailstock; a means for providing a cutting fluid flow; and the laser material removal apparatus, wherein the headstock, the tailstock, and the laser head are within a cabinet.

Also disclosed is a method of metalworking, the method comprising: providing a workpiece; providing a cutting tool; providing a laser material removal apparatus comprising a housing comprising a bottom cover, a top cover on the bottom cover, a nozzle on a side surface of at least one of the bottom cover and the top cover, and a gas flow path extending from a posterior portion of the nozzle to an inlet in at least one of the bottom cover and the top cover, and a laser head disposed in the housing and in optical communication with a laser; providing a gas flow to the gas flow path; providing a cutting fluid flow associated with the workpiece, wherein the cutting fluid flow, the cutting tool, and the laser material removal apparatus are in a cabinet; rotating the workpiece; removing material from the workpiece with the cutting tool; and removing material from the workpiece with the laser.

The method may comprise displacing the coolant flow on an optical member of the laser head with the gas flow, e.g., the purge gas and/or the assist gas. The method may comprise providing a controller, and controlling the gas flow with the controller. In an embodiment, the controller is configured to alternately provide the purge gas and the assist gas. In an embodiment, the method may further comprise retaining the workpiece within the headstock between removing material with the cutting tool and laser machining. In an embodiment, the method may further comprise retaining the workpiece within the cabinet between removing material with the cutting tool and laser machining. In an embodiment, the method may further comprise simultaneously removing material from the workpiece with the cutting tool and laser machining. The cutting tool may be configured to perform at least one of turning, threading, milling, drilling, and reaming. In an embodiment, the method may further comprise alternatively providing the purge gas and the assist gas, wherein the assist gas is provided when laser machining.

Also disclosed is a system for material removal comprising: a headstock; a cutting tool; a means for providing a coolant flow; and a laser material removal apparatus, wherein the headstock, the cutting tool, and the laser material removal apparatus are within a cabinet, and wherein the laser material removal apparatus comprises a laser head, a housing disposed about the laser head; a nozzle comprising an aperture and disposed in the housing; a purge gas inlet disposed in the housing and in fluid communication with the nozzle; and an assist gas inlet disposed in the housing and in fluid communication with the nozzle.

In an embodiment, the laser head may have an adjustable focal length. A servo may be provided for adjusting the focal length. In an embodiment, the system may comprise a controller, and the controller may be configured to control at least one of the headstock, the cutting tool, coolant flow, gas flow, and the laser. In an embodiment, the gas may be a purge gas and/or an assist gas, and the controller may be configured to alternately provide the purge gas and the assist gas.

### Examples

### Example 1

A laser material removal apparatus having a housing as shown in FIG. 2A was mounted in a sliding headstock lathe. A purge gas flow of dry air was provided to the inlet of the laser material removal apparatus. The lathe was then used to rotary machine a tube, and during the machining a cutting fluid was used. An assist gas flow comprising nitrogen was then provided to the inlet. The tube was then laser machined with the laser material removal apparatus.

### Comparative Example 1

A laser head not within a housing was mounted in a sliding headstock lathe. The lathe was then be used to rotary machine a tube, and during the machining a cutting fluid was used. The tube was then laser machined with the laser head. After 30 minutes of use the laser head would not cut. Subsequent analysis found the laser head to be contaminated with fluid.

The invention is described with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

1. A housing for a laser head, the housing comprising:
a bottom cover;
a top cover on the bottom cover;
a nozzle on a side surface of at least one of the bottom cover and the top cover; and
a gas flow path extending from a posterior portion of the nozzle to an inlet in at least one of the bottom cover and the top cover, wherein the inlet is on a bottom surface of at least one of the bottom cover and the top cover, and wherein the bottom surface is opposite the nozzle.

2. (canceled)

3. The housing of claim 1, wherein the inlet is in fluid communication with an aperture of the nozzle.

4. The housing of claim 3, further comprising a connector on the inlet.

5. The housing of claim 1, wherein the gas flow path extends from the posterior portion of the nozzle to the inlet, which is in at least one of the bottom cover and the top cover.

6. The housing of claim 1, further comprising an access on a top surface of the top cover.

7. The housing of claim 6, wherein the access is threadedly engaged.

8. A laser material removal apparatus comprising a laser head disposed within the housing of claim 1.

9. The laser material removal apparatus of claim 8, further comprising a lens disposed on a beam path and between the laser head and the nozzle.

10. The laser material removal apparatus of claim 9, further comprising an adjustment servo configured to adjust the lens.

11. The laser material removal apparatus of claim 8, wherein the laser head is a fiber laser head.

12. A lathe comprising:
a headstock;
a tailstock;
a means for providing a cutting fluid flow; and
the laser material removal apparatus of claim 8, wherein the headstock, the tailstock, and the laser head are within a cabinet.

13. The lathe of claim 12, further comprising a controller configured to control the headstock, the tailstock, a gas flow which is directed to the inlet of the laser material removal apparatus, and a laser which is in optical communication with the laser head.

14. The lathe of claim 13, wherein the laser head is optically connected to the laser by a fiber cable.

15. The lathe of claim 14, wherein the fiber cable and a gas supply pass through a connector disposed in the housing, and wherein the gas supply is configured to direct a gas to the gas flow path.

16. The lathe of claim 13, wherein the laser has a power of greater than 50 watts.

17. The lathe of claim 16, wherein the laser has a modulation range of 1 kilohertz to 100 kilohertz.

18. The lathe of claim 17, wherein the laser has power which is selectable between continuous wave operation and 10 percent of the continuous wave operation.

19. The lathe of claim 12, wherein the gas flow path comprises a purge gas flow path and an assist gas flow path, and further comprising a controller, which is configured to alternately provide a purge gas flow and an assist gas flow.

20. The lathe of claim 12, wherein the tailstock is configured to provide at least 5 axes of movement relative to the headstock.

21. A method of metalworking, the method comprising:
providing a workpiece;
providing a cutting tool;
providing a laser material removal apparatus comprising
a housing comprising
a bottom cover,
a top cover on the bottom cover,
a nozzle on a side surface of at least one of the bottom cover and the top cover, and
a gas flow path extending from a posterior portion of the nozzle to an inlet in at least one of the bottom cover and the top cover, wherein the inlet is on a bottom surface of at least one of the bottom cover and the top cover, and wherein the bottom surface is opposite the nozzle, and
a laser head disposed in the housing and in optical communication with a laser;
providing a gas flow to the gas flow path;
providing a cutting fluid flow associated with the workpiece, wherein the cutting fluid flow, the cutting tool, and the laser material removal apparatus are in a cabinet;
rotating the workpiece;
removing material from the workpiece with the cutting tool; and
removing material from the workpiece with the laser.

22. The method of claim 21, wherein the gas flow comprises at least one of a purge gas flow and an assist gas flow, and wherein the method further comprises purging the nozzle with the purge gas flow.

23. The method of claim 22, further comprising alternatively providing the purge gas flow and the assist gas flow, wherein the assist gas flow is provided during the removing material with the laser.

24. The method of claim 21, further comprising displacing the cutting fluid flow on the nozzle with the gas flow.

25. The method of claim 21, further comprising controlling a headstock, the cutting tool, the laser, and the gas flow with a controller.

26. The method of claim 25, wherein the gas flow comprises a purge gas flow and an assist gas flow, and wherein the controller is configured to alternately provide the purge gas flow and the assist gas flow.

27. The method of claim 21, further comprising retaining the workpiece within a headstock between the removing material with the cutting tool and the removing material with the laser.

28. The method of claim 27, further comprising retaining the workpiece within the cabinet between the removing material with the cutting tool and the removing material with the laser.

29. The method of claim 21, further comprising simultaneously removing material from the workpiece with the cutting tool and the laser.

30. The method of claim 29, wherein the laser is a fiber laser having a power of greater than 50 watts.
